(19) United States
(12) Patent Application Publication
(10) Pub. No.: US 2014/0026651 A1
(43) Pub. Date: Jan. 30, 2014

(54) Linear relationship between tracks

(71) Applicant: VEGA Grieshaber KG, Wolfach (DE)

(72) Inventors: Roland WELLE, Oberwolfach (DE); Christian Hoferer, Offenburg (DE); Karl Griessbaum, Muehlenbach (DE)

(73) Assignee: VEGA Grieshaber KG, Wolfach (DE)

(21) Appl. No.: 13/947,785

(22) Filed: Jul. 22, 2013

Related U.S. Application Data
(63) Continuation of application No. PCT/EP2012/064742, filed on Jul. 26, 2012.
(60) Provisional application No. 61/676,058, filed on Jul. 26, 2012.

(51) Int. Cl. G01F 23/28

(52) U.S. Cl. CPC G01F 23/28
USPC 73/290 V

(57) ABSTRACT

Described are a delay-based fill-level measurement device and a delay-based fill-level measurement method, in which the echoes of successive echo curves are grouped and combined into tracks. Subsequently, the linear relationship between two tracks is determined and this linear relationship is used so as to determine one or more unknowns therefrom. From this, for example the dielectric constant of the filling medium, the container depth or probe length of a probe of the device or the position of an expected echo can be derived.

### REFERENCE TO RELATED APPLICATIONS

This application claims the benefit of the filing date of International Patent Application No. PCT/EP2012/064742 filed 26 Jul. 2012, the disclosure of which is hereby incorporated herein by reference and of U.S. Provisional Patent Application No. 61/676,058 filed 26 Jul. 2012, the disclosure of which is hereby incorporated by reference.

### FIELD OF THE INVENTION

The invention relates to the technical field of fill-level measurement. In particular, the invention relates to a delay-based fill-level measurement device, to a delay-based fill-level measurement method for carrying out a tracking method for grouping echoes, which in each case originate from the same reflector, from echo curves captured at different times, to a processor for carrying out the tracking method, to a computer-readable medium and to a program element.

### TECHNICAL BACKGROUND

Delay-based fill-level measurement devices work by using frequency modulated continuous waves, FMCW, or pulse delay. These measurement devices emit electromagnetic or acoustic waves towards a filling material surface. These waves are subsequently reflected in whole or in part from various reflectors. These reflectors may in particular be the surface of the filling medium (for example water, oil, other fluids or mixtures of fluids or bulk material), the base of the container in which the filling medium is stored, impurities, separating layers between different filling materials (for example the separating layer between water and oil) or stationary interference points in the container, such as projections or other container fixtures.

The transmission signal which is reflected in this manner (also referred to in the following as the reception signal or echo curve) is subsequently received and recorded by the fill-level measurement device.

Fill-level measurement devices typically work in pulsed operation, that is to say they emit a respective transmission signal in pulsed form at various times, and the resulting reflected pulse of the transmission signal (reception signal) is subsequently, as disclosed above, detected by the sensor system of the fill-level measurement device. From this, the evaluation unit of the device subsequently derives the location or position of the filling medium surface. Thus, in other words, the fill level is determined from this received pulse.

Other fill-level measurement devices work according to FMCW principle. In this case, frequency-modulated waves are continuously radiated towards the container, and the reflected signal components are processed in the device together with the instantaneously radiated signal. This processing results in a frequency spectrum which can be converted into an echo curve by known methods.

The data which are thus obtained, which may already have been processed and evaluated, can be supplied to an external device. They may be provided in analogue form (4 . . . 20 mA interface) or in digital form (field bus).

The data may also be transmitted wirelessly.

The received echo curve, which is the transmission pulse (emitted at a particular time tᵢ) reflected on one or more reflectors, typically has one or more maxima and/or minima, the electrical distances of which from the transceiver unit can be determined from the location of the corresponding maxima or minima.

These electrical distances correspond to the delays of the corresponding signal components of the pulse. The physical distances, that is to say the actual distances, can be calculated therefrom by taking account of the propagation speed of the signal. In other words, the electrical distances are x-coordinates of the received signal if it is plotted in a coordinate system (cf. FIG. 7). In this context, no physical environmental influences which lead to an altered propagation speed of the electromagnetic waves are taken into account. The electrical distance can thus be considered an ideal condition of the model. The physical distances are related thereto. These are the distance values which can be physically detected directly at the sensor (for example with a meter measurement). The coordinate system of the electrical distance can be converted into a coordinate system based on the physical distance by translation (compensating an offset) and dilation (compensating the delay). This concept is explained again more explicitly in EP 11 167 924.7.

Unfavourable relationships in the container may mean that a particular echo of an echo curve cannot be assigned unambiguously to a track or that this echo cannot be detected in the echo curve, for example because it has descended into noise.

It is also possible that the physical relationships in the container may be altered, for example because the composition of the filling medium changes.

Events of this type may lead to imprecise measurements, or even make it impossible to determine the fill level at a particular moment.

### SUMMARY

In accordance with a first aspect of the invention, a delay-based fill-level measurement device is specified which comprises a transmitter unit, a receiver unit and an evaluation unit. The transmitter unit serves to emit a transmission signal, which is reflected on a filling material surface of a filling medium (which is for example located in a container) and at least on a second reflector. The delay-based fill-level measurement device thus transmits the transmission signal towards the filling material surface.

The receiver unit (e.g. a transceiver unit) serves to detect the reflected transmission signal (also referred to as the received signal, received pulse or echo curve). The receiver unit (e.g. the transceiver unit) may be an independent unit. However, it may also share particular assemblies with the transmitter unit or even be the same unit. In the case of fill-level radar, the shared assembly may for example be a transceiver antenna.

The reflected transmission signal is an echo curve, which comprises a plurality of echoes if there are a plurality of reflectors. However, these echoes in the echo curve cannot always be clearly recognised, since in some cases the amplitude thereof is too low or since the overlap with one another in part.

The evaluation unit serves to carry out a tracking method to group echoes which in each case originate from the same reflector and belong to echo curves which are captured at different times.

In the following, the tracking method is described again with reference to the drawings. Ultimately, the delay-based fill-level measurement device receives echo curves at different times, resulting in a sequence of echo curves over time which mirror the development of the relationships in the container over time. The evaluation unit can now analyse each individual echo curve and establish the position of the maxima or minima.

An object of the tracking method is to assign each maximum or minimum to a reflector in the container or to classify it as an unassignable echo. If this assignment is carried out correctly, the development of the fill level over time and the development of the positions of the various other reflectors in the tank over time may be obtained therefrom. The development of the positions over time can subsequently be recorded in a diagram.

Assuming that there is a constant emptying or filling rate in the container, the individual measurement points (that is to say the sequence of electrical distances or positions of the reflectors which are calculated from the sequence of echo curves, including the position of the filling material surface) can be reproduced approximately using a straight line segment, as is shown for example in FIG. 2. Forming straight line segments is only one embodiment of a memory-optimised tracking method. Any other connecting line which indicates the path covered by an echo which originates from a reflection point is conceivable at this point. Echo positions at which an echo of a track was located at previous moments can thus be connected by any sequence of curves. In the simplest case, this corresponds to a straight line. However, higher order polynomials or even non-linear functions may be used, depending on the situation.

If the filling or emptying rate of the fill level changes, this leads to a kink in the calculated curve when based on a tracking method using straight-line segment formation. In this case, there are thus two touching straight line segments having different gradients.

Since the electrical distances are taken into account for this purpose, and not the actual physical distances, the position of the base echo or of other stationary reflectors which are located below the filling material surface changes as the fill level increases or decreases. This is shown schematically in FIG. 8.

These touching straight line segments are referred to as tracks. FIG. 8 shows three tracks T₁, T₂, T₃ of this type.

Generally, one of these tracks describes to the position of the filling material surface at various times, another track describes the position of the base echo, and a third track for example describes the position of a stationary reflector below the filling material level, the position of a separating layer between two different filling media or the probe end in the case of fill-level measurement with guided waves.

The evaluation unit of the delay-based fill-level measurement device is thus configured to determine a first track of a first group of echoes, which originate from a first reflector (for example the filling material surface, the container base etc.), and of a second track of a second group of echoes, which originate from a second reflector (in this case for example the container base, the filling material surface etc.), each track describing the delay of the corresponding transmission signal from the transceiver unit to the reflector assigned to the track and back to the transceiver unit at the various times (that is to say at the various moments when the various transmission signals were emitted).

The evaluation unit is further configured so as to determine a linear relationship between the first track and the second track.

This linear relationship is a functional correspondence between all of the positions through which a first track has passed and all of the further positions through which a second track has passed. How this functional correspondence is calculated is explained below, in particular with reference to FIGS. 1 to 4.

Since the electrical positions of the fixed reflectors below the filling material surface change in a manner corresponding to the position of the filling material surface itself, there is in mathematical terms a linear correspondence or linear relationship between every two tracks, which can be estimated by using the various echo curves.

After determining the linear relationship between the first track and the second track, the evaluation unit can assign a first echo of a further echo curve to the first track. This further echo curve is for example received at a later moment than the echo curves in the sequence over time which are used to determine the linear relationship between the two tracks. This therefore involves a new measurement.

The evaluation unit can subsequently determine one or more unknowns from the linear relationship between the first track and the second track.

The unknown is for example the expected position of a second echo of the further echo curve. For this purpose, the evaluation unit also uses the position of a first echo in the further echo curve, which is assigned to the first track, as well as the linear relationship.

Given knowledge of the linear correspondence between the two tracks and of a further measurement point (the position of an echo of a further echo curve), which is assigned to the first track, the expected position of the corresponding other echo (of the second track) can thus subsequently be calculated or estimated.

The invention thus makes it possible, irrespective of amplitude relationships or filling rates, to follow the fill-level echo reliably even in the presence of interference echoes, base echoes or multiple echoes.

Since the evaluation unit can determine the relationship between any two tracks, this method can be used not only for the fill-level echo, but also for the other echoes of the echo curve.

In accordance with one embodiment of the invention, the first group of echoes is the transmission signals reflected from the filling material surface.

In accordance with a further embodiment of the invention, the unknown is the expected position of an echo, assigned to the second track, of a further echo curve, the further echo curve being received at a later moment than the above-described echo curves.

In accordance with a further embodiment of the invention, the unknown is the dielectric constant of the filling medium.

In accordance with a further embodiment of the invention, the delay-based fill-level measurement device is a TDR fill-level measurement device, the unknown being the length of a probe of the TDR fill length measurement device.

In accordance with a further embodiment of the invention, the evaluation unit is configured so as to detect, from the determined length of the probe by comparison with the actual probe length, whether the probe is soiled.

In accordance with a further embodiment of the invention, the evaluation unit is configured so as to calculate, from the determined length of the probe by comparison with the actual probe length, a quality of the (previously determined) dielectric constant. In this case, it is assumed that the probe is not soiled.

In accordance with a further embodiment of the invention, the unknown is the height of the container in which the filling medium is located or the position of a stationary reflector in the container which is located below the filling material surface.

In accordance with a further embodiment of the invention, the track and the linear relationship between each two tracks are determined by a recursion or an estimation method.

Thus, the individual (electrical) positions of the echoes, respectively assigned to a track, of the different echo curves can be approximated by one or more straight line segments.

In accordance with a further aspect of the invention, the linear relationship between the first track and the second track is determined by a recursive method.

In accordance with a further aspect of the invention, a delay-based fill-level measurement method is specified for carrying out a tracking method for grouping echoes, which in each case originate from identical reflectors, from echo curves captured at different times. The method comprises the following steps:

transmitting a transmission signal, which is reflected on a filling material surface of a filling medium and at least on a second reflector;
capturing the reflected transmission signal, which is an echo curve comprising a plurality of echoes;
determining a first track of a first group of echoes which originate from a first reflector and a second track of a second group of echoes which originate from a second reflector, each track describing the delay of the corresponding transmission signal from the transceiver unit to the reflector assigned to the track and back to the transceiver unit at the different times;
determining a linear relationship between the individual positions of the first track and the positions of the second track; and
determining one or more unknowns from the linear relationship between the first track and the second track.

The method may also comprise others of the steps disclosed above and in the following.

In accordance with a further aspect of the invention, a processor is specified for carrying out a tracking method for grouping echoes, which in each case originate from identical reflectors, from echo curves captured at different times. The tracking method is the method disclosed above and in the following.

In accordance with a further aspect of the invention, a computer-readable medium is specified, on which a program is stored, which, when implemented on a processor of a delay-based fill-level measurement device, instructs the processor to carry out the method steps disclosed above and in the following.

In accordance with a further aspect of the invention, a program element is specified, which, when implemented on a processor of a delay-based fill-level measurement device, instructs the processor to carry out the method steps disclosed above and in the following.

In the following, embodiments of the invention are described with reference to the drawings.

### BRIEF DESCRIPTION OF THE DRAWINGS

FIG. 1 is a schematic drawing of the correspondence of track positions (electrical distances of reflectors) which are obtained from echo curves in a sequence over time, in accordance with an embodiment of the invention.

FIG. 2 shows the progressions over time of two tracks.

FIG. 3 is a schematic drawing of the linear relationship of track positions of two tracks in accordance with an embodiment of the invention.

FIG. 4 shows a method for reducing the combinatorics in fill-level determination in accordance with an embodiment of the invention.

FIG. 5 shows a fill-level measurement device comprising a filling material container in accordance with an embodiment of the invention.

FIG. 6 shows a further fill-level measurement device comprising a filling material container in accordance with an embodiment of the invention.

FIG. 7A shows an echo curve received at a first time.

FIG. 7B shows an echo curve received at a second moment.

FIG. 8 shows the development of a plurality of tracks over time.

FIG. 9 shows the linear relationships between two tracks in each case.

FIG. 10 is a flow chart of a method in accordance with an embodiment of the invention.

### DETAILED DESCRIPTION OF EMBODIMENTS

The drawings are schematic and not to scale. If like reference numerals are used in different drawings, they denote like or similar elements. However, like or similar elements may also be denoted by different reference numerals.

In the following, a possible embodiment of the evaluation unit of a fill-level measurement device is to be described. The received echo curve may initially undergo preparation. By way of selective digital processing of the signal, for example by way of digital filtering, it may more easily be possible for a method for echo extraction to determine the significant signal components from the echo curves.

For further processing, the extracted echoes may for example be stored in the form of a list. However, further possibilities other than storage in a list are also available for access to the data. The tracking function block assigns the echoes of an echo curve at moment tᵢ to the echoes of the following echo curve at moment the echoes having passed through the same physical reflection point and covered the same route (that is to say having been produced by reflection of the transmission signal on the same reflector).

Tracking methods are known. More detailed information may be found for example in WO 2009/037000 A2.

A key aspect of the invention is to place the development over time of two tracks, that is to say the development over time of the positions of two different physical reflection points or two reflections, in a relation with one another and to determine therefrom the parameters of a linear correspondence. Each track consists of a sequence of position values which have been determined from the echoes of an echo curve. Since in fill-level measurement devices the distance from the sensor to the filling material is to be measured, the concept of distance is also used, alongside the concept of position.

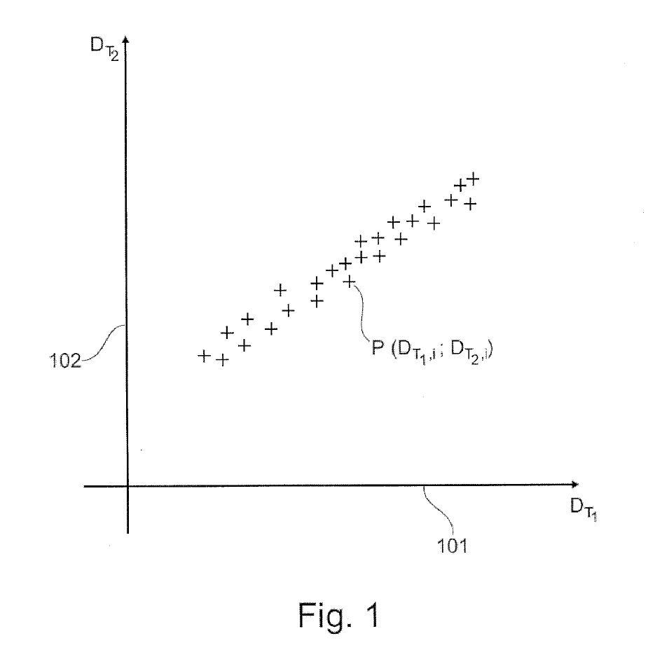

FIG. 1 is intended to illustrate in greater detail the situation regarding the relation between two tracks. The axis system shows a scatter plot which is formed from the distance pairs of the individual position values of two tracks. By way of example, the tracks are denoted Track T₁ and Track T₂. However, any other conceivable combination of two different tracks may be used.

Each distance pair is marked by a cross. The x-axis (101) comprises the distance D of track T₁, and the y-axis (102) comprises the distance D of track T₂. This arrangement is not necessarily required. Thus, the x-axis and y-axis could also be swapped over. The unit of measurement of the axis scaling is also irrelevant to the invention. Thus, the electrical distance D in this instance is thus merely exemplary. Temporal scaling of the position in accordance with the echo curve would also be possible. A distance pair is specially marked in FIG. 1 for more precise explanation. The distance pair P(D_{T1,1}; D_{T2,1}) describes a pair of values of two positions of track T₁ and track T₂ at the moment i at which the echo curve was generated. The other points in the diagram, which are not denoted more precisely, come from other echo curves which were captured by the sensor at different moments. A new echo curve which is generated by the sensor, which comes from a further signal processing run and the echoes of which have been assigned to the tracks, would add one additional point to the drawing.

The correspondence shown in FIG. 1 of the positions of the two tracks makes it clear that the positions of track T₁ and track T₂ can be brought into a relation. This means that track T₁ and track T₂ are in a functional correspondence. This is based on a straight line equation which describes the scatter plot. Mathematically, this correspondence can be described as follows:

D_{T2,k}=a₁·D_{T1,k}+a₀+eₖ (1.1)

D_{T2,k} is the position of track T₂ of the measurement at moment k.

D_{T1,k} is the position of track T₁ of the measurement at moment k.

aₙ and a₁ are the parameters of a straight line, and describe the linear correspondence between the position of track T₁ and track T₂.

eₖ is the error in the correspondence for the measurement at moment k.

The parameter a₁ of the function is without a unit of measurement, whilst a_{c}, has the same unit of measurement as D_{T2,k} and D_{T1,k}. eₖ has the same unit of measurement as D_{T2,k} and D_{T1,k}. It is necessary to postulate an error in the specified correspondence, since in this way the errors in the model can be reproduced in combination. The parameters a₁ and a₀ are dependent on the given properties of the measurement point at which the sensor is used. In addition, the parameters are dependent on the progression of the tracks which are being brought into a relation with one another.

Formula (1.1) is merely one feature of the correspondence. Naturally, it can be applied to each track, and does not necessarily require track T₁ and track T₂ as a basis. However, the values of the parameters a₁ and a₀ are then different from the correspondence between track T₁ and track T₂.

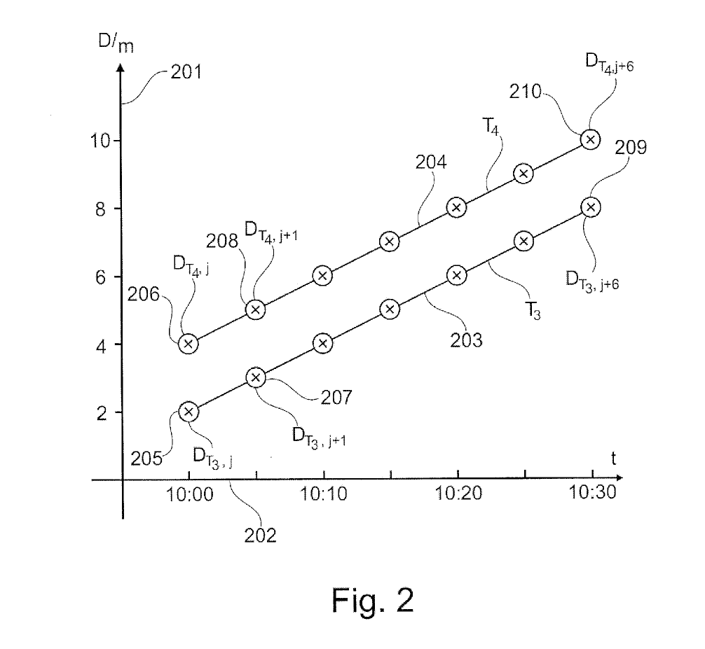

FIG. 2 shows the exemplary progression of two tracks (T₃ 203 and T₄ 204) over time. The x-axis 201 represents the distance in metres and the y-axis 202 represents the measurement time t. The supporting points 205, 207, 209 . . . and 206, 208, 210 . . . of the tracks 203, 204 resulting from the echo positions of the echo curves at the respective moment j are each marked with an x.

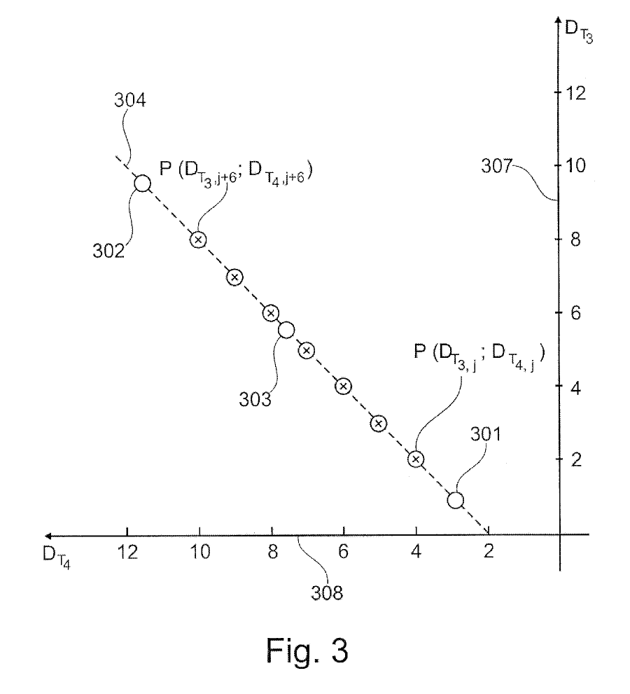

If the supporting points from FIG. 2 are transferred into a diagram, which like FIG. 1 illustrates the relation between the two tracks, the diagram of FIG. 3 is obtained. The x-axis 307 in this case comprises the positions of track T₃ and the y-axis 308 in this case comprises the positions of track T₄. In addition, the linear correspondence 304 between the two tracks is drawn in in the form of a broken line. It can now be seen that, aside from the supporting points in FIG. 3, further statements about the correspondence of the two tracks can also be made. The correspondence can be applied both for positions 303, which are located between the supporting points, and for positions 302 and 301, which are located alongside the supporting points. This further means that if the position of one track is known the position of the other track can be predicted. This prediction can be reversed. In the example of FIG. 3, this means that the position of track T₄ can be predicted from the position of track T₃ and vice versa. In addition, not only can a prediction be made, but an estimate of the position of a track can also be specified if it has not been possible to determine the position of the track because of unfavourable signal ratios.

Determining the Parameters a₀ and a₁

The parameters a₀ and a₁ may be determined independently by the sensor using suitable parameter estimation methods which are routine to a person skilled in the art. As a result of the error in the underlying model, what is known as estimation of the parameters is advantageous, and minimises the error in determining the parameters. The estimation itself may take place in various ways. It is possible to apply conventional parameter estimation methods, such as LS estimation. LS estimations are disclosed explicitly in the literature. An estimation may for example be configured as follows:

D_{T2}=â₁·D_{T1}+â₀

D_{T2} is the position of track T₂

D_{T1} is the position of track T₁

â₀ and â₁ are the estimated parameters of a straight line, and describe the linear correspondence between the positions of track T₁ and track T₂.

So as not to have to keep the position pairs continuously in the memory, the aforementioned methods may also be implemented recursively. The estimation may initially be erroneous, but improves with an increasing number of pairs of values. It is of course necessary initially to determine the parameters, before a prediction as to the current position of one track can be made from the position of the other track.

The disclosed invention can usefully be expanded. The echo curve often exhibits a large number of echoes, and this leads to many tracks. In the disclosed method, in the general case, all of the tracks are placed in relation with one another. This means that from each individual track a prediction can be made directly about the location of each other track. The number A of functional correspondences to be made can be calculated as a function of the number N of tracks, using the formula

A=N·(N−1)/2

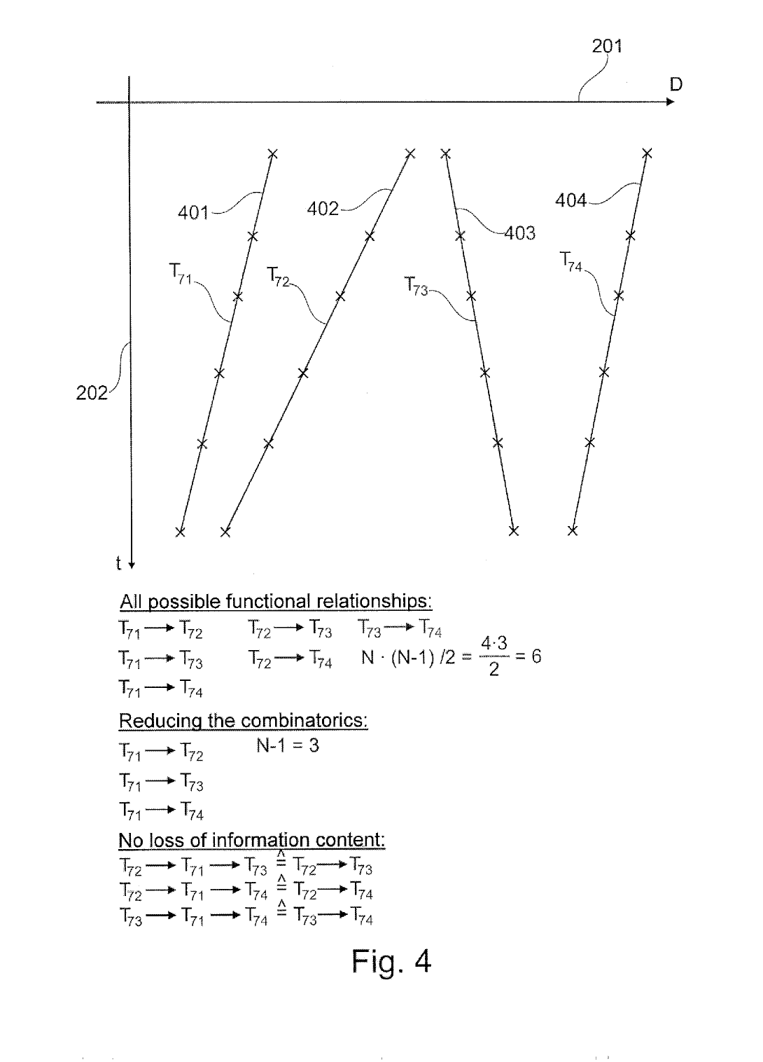

So, if four tracks are being followed, six correspondences have to be produced, calculated, maintained and stored. An expansion of the invention results from selectively reducing the combinatorics. FIG. 4 shows the complete listing in the case of four different tracks. The functional correspondences are shown by an arrow. The direction of the arrow is merely exemplary, since the correspondence can also be reversed. For example, if the correspondence T₇₁→T₇₂ is known, the correspondence T₇₂→T₇₁ can also be calculated by taking the inverse function. Further, FIG. 4 shows a possibility for reducing the combinatorics without reducing the predictive power of the invention. For example, the reduction has been carried out using track T₇₁. The correspondences between T₇₂ and T₇₃, T₇₂ and T₇₄, and T₇₃ and T₇₄ can be calculated from the correspondences between T₇₁ and T₇₂, T₇₁ and T₇₃, and T₇₁ and T₇₄. It is thus only necessary to store and expand

A=N−1

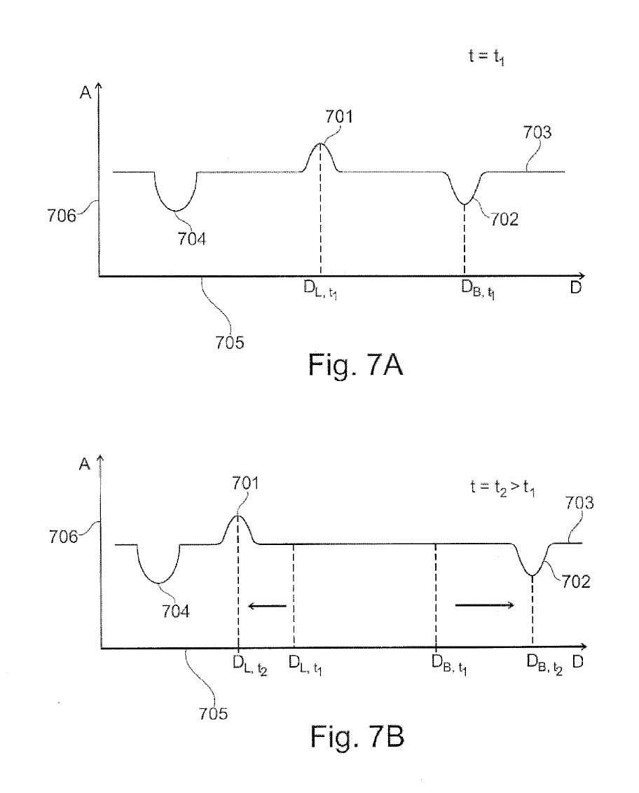

functional correspondences (therefore three in FIG. 4). The reduction assumes that a track has to be selected as a starting point for the reduction. This track could be referred to as an intermediate track. In the example of FIG. 4, this is track T₇₁. Naturally, any other track could also be selected as the intermediate track for the reduction. The fact that no information content is lost is demonstrated by the calculation chain of FIG. 7. For example, the correspondence between T₇₂ T₇₃ can be determined from the two correspondences T₇₁→T₇₂ and T₇₁→T₇₃. For this purpose, the inverse function T₇₁←T₇₂ of T₇₁→T₇₂ has to be taken. Subsequently, the expanded correspondence T₇₂→T₇₁→T₇₃ can be set up and the location of track T₇₃ can be determined from track T₇₂ without having estimated in advance the parameters of the functional expression for the correspondence T₇₂→T₇₃. This results in advantages in performance, since the estimation of the parameters is found to be computationally intensive. Memory space is also saved.

The key aspect of the expansion is thus that the combinatorics can be reduced if the calculation always goes via an intermediate track T_{C} when the position of a track T_{A} is calculated from the position of a track T_{B}.

A key aspect of the disclosed method involves the estimation of the parameters of a target function, which subsequently describes the correspondence in position between two tracks. If the parameters of the target function have been determined sufficiently well during the operation of the fill-level measurement device, from the position of one track a conclusion can be drawn as to the position of another track. Since the parameters are dependent on the measurement point (place of installation, connector, flange, container base, container cover, filling material, fixtures in the container), parameterisation cannot take place during production.

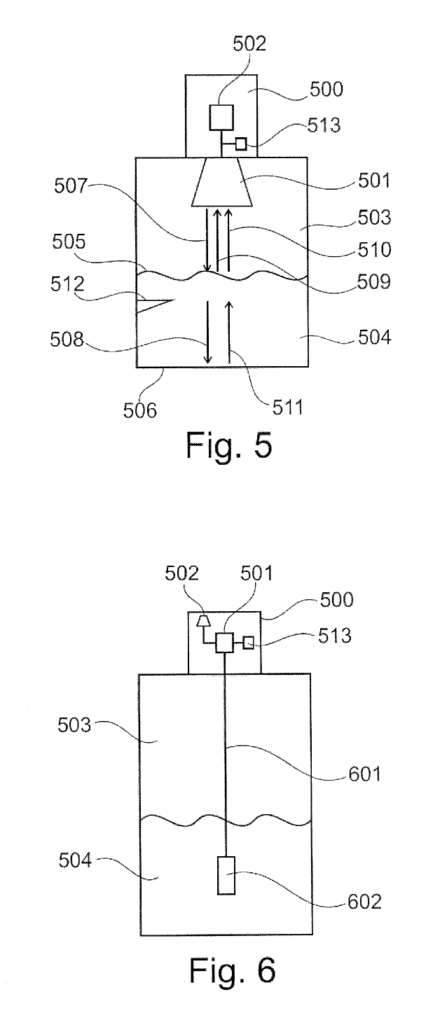

FIG. 5 shows a delay-based fill-level measurement device 500, which is installed on or in a container. The fill-level measurement device 500 is for example a fill-level radar or an ultrasound device. This delay-based fill-level measurement device 500 emits freely radiating waves, for example in the form of pulses 507, towards the filling material surface 505. In the case of fill-level radar, an antenna 501 is provided for this purpose, for example in the form of a horn antenna. This transmission signal or the transmission pulse 507 is generated by means of a signal generator unit 513 and emitted via the transmission/transceiver unit 501. The emitted transmission signal 507 is subsequently incident on the filling material surface 505 of the filling material 504 which is located in the container. Beforehand, it passes through the medium located above the filling material surface 505, for example the container atmosphere.

A component of the transmission signal 507 is subsequently reflected on the filling material surface and moves back to the transmission/transceiver unit 501 as an echo 509. Another component of the transmission signal 507 enters the filling medium 504 and moves to the base 506 of the container (see signal component 508), where it is subsequently reflected and moves back towards the transmission/transceiver unit 501 as what is known as a base echo 511. Part of this base echo is reflected back again (on the filling material surface 505). However, another part of this base echo 510 penetrates the filling material surface 505 and can subsequently be received by the transmission/transceiver unit 501 and passed to the evaluation unit 502.

Part of the transmission signal 507 may also be reflected on other reflectors. A projection 512 attached to the container wall is shown as an example of this, and is located below the filling material surface.

FIG. 6 shows a further example of a delay-based fill-level measurement device 500. This is a TDR fill-level measurement device, which operates using the principle of guided waves. These may be guided microwaves or other wave-like transmission signals, which are guided along a wire 601 or else for example in the inside of a hollow guide, towards the filling material surface and also in part into the filling material. At the end of the wire 601, there is for example a weight 602 for tensioning the wire.

FIG. 7A shows an example of an echo curve 703 which is recorded in the evaluation unit. The echo curve 703 has two minima 702, 704 and one maximum 701.

At this point, it should be noted that the horizontal axis 705 represents the electrical distance (which corresponds to the delay of the individual portions of the echo curve 703) and the vertical axis 706 represents the amplitude of the individual portions of the echo curve 703.

The maximum 701 is for example the echo reflected on the filling material surface, and the minimum 702 is for example the echo reflected at the probe end of the probe 601, 602 shown in FIG. 6 or the echo reflected on the container base 506 shown in FIG. 5.

This echo curve is received at a moment t₁.

FIG. 7B shows a corresponding echo curve which was received at a subsequent moment t₂. As can be seen from this curve, both the filling material echo 701 and the probe end or base echo 702 have been displaced, but in opposite directions. This is because the probe end echo or base echo is located below the filling material surface.

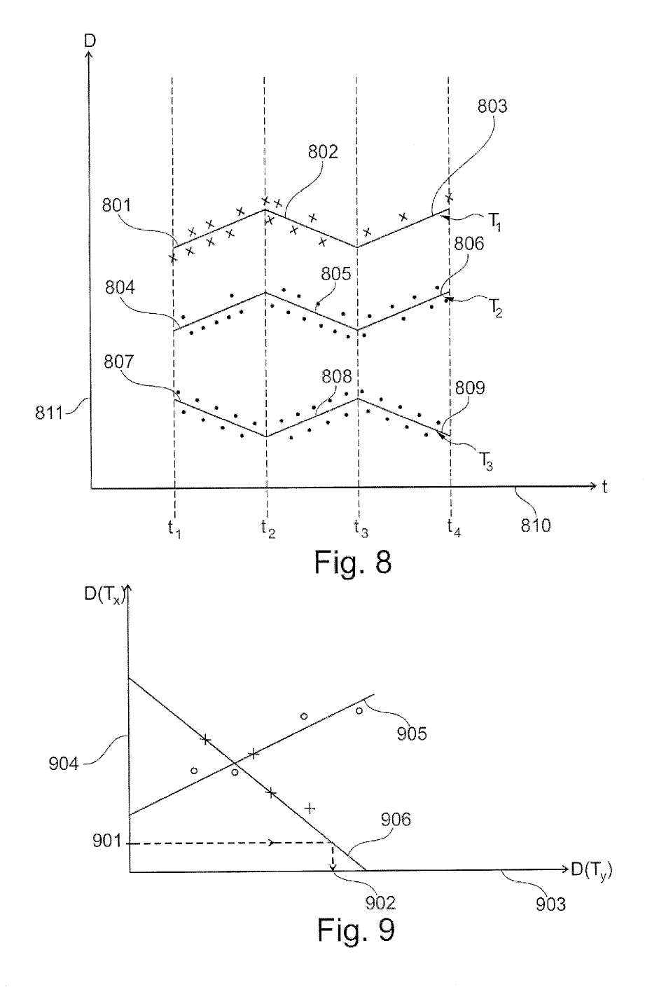

If the evaluation unit now establishes that the echo 701 represents echoes which originate from an identical reflector (in this case from the filling material surface), and if it establishes that the echoes 702 likewise originate from another identical reflector (container base or probe end), the echoes 701 can be combined into a first group and the echoes 702 can be combined into a second group. If a plurality of echo curves are received at different moments, the electrical distances of the individual echoes can be represented by tracks, for example in the form of touching straight line segments. This is shown in FIG. 8. The horizontal axis 810 denotes the moments tᵢ at which the individual echo curves were measured and the vertical axis 811 denotes the electrical distance which the various echoes of the individual echo curves have covered.

The first track T₁ consists of three straight line segments 801, 802, 803, which each have a different gradient according to the rate at which the container is filled or emptied. Straight line segment 801 describes the container being filled between moments t₁ and t₂, segment 802 describes emptying between moments t₂ and t₃, and segment 803 describes filling again between moments t₃ and t₄.

As is symbolised by the crosses around the three straight line segments 801, 802, 803, a large number of measurements (echo curve captures) have been taken, in such a way that the three straight line segments 801 to 803 can be determined sufficiently precisely.

The received echo curves also comprise two further groups of echoes, the electrical distances of which are approximated by the straight line segments 804, 805, 806 and 807, 808, 809 respectively.

As can be seen from FIG. 8, the kinks in the three tracks T₁ to T₃ are each located at the same moments t₂, t₃ and t₄.

Subsequently, any two of the tracks can be placed in a relationship with one another so as to determine the functional correspondence between the individual tracks. If two pairs of tracks are taken in each case, this results in two approximate straight lines 905, 906 (see FIG. 9). In this case, the horizontal axis 903 denotes the electrical distance of the echoes of a first echo group (that is to say of a first track Ty) and the vertical axis 904 denotes the electrical distance of the echoes of a second echo group (that is to say of a second track Tx). Experts often use the term “track position” in this connection. As described above, this refers to the corresponding electrical distance which a particular echo of a particular echo curve has covered on its path to the transceiver unit.

By determining the functional correspondence, the tracking of the echo can be improved.

By determining the functional correspondence between any desired tracks, it is possible to determine the position of a track from the position of a second track.

The functional correspondence may be determined in the form of a linear correspondence (also referred to as a “linear relationship” in the context of the invention)

D_{T}_{₂}=â₁·D_{T}_{₁}+â₀

This was disclosed previously above. The hat symbols above the parameters a₀ and a₁ mean that these parameters are estimates.

Classification of the tracks is not necessary. In this context, classification is understood to mean that predictions can be made as to whether for example the track of the fill-level echo, the base echo, an interference echo or a multiple echo is involved.

If knowledge is obtained as to the fill level or the associated fill-level track, further unknown values can be calculated.

### Determining the Dielectric Constant

To determine the dielectric constant of the electromagnetic wave in the medium to be measured, the following are required:

1. track for the fill level
2. track for a fixed reflection point (echo) below the fill level
a. container base/probe end in the case of a guided microwave
b. interference echo (metal strut etc.).

In the following formulae, reference is made to the fill-level echo and the base echo by way of example. However, another echo brought about by a reflector located below the filling material surface can also be used instead of the base echo. The base echo is merely used as an example.

By a derivation not discussed in greater detail, the following correspondence is obtained for the parameter a₁:

$${a}_{1} = \frac{\sqrt{{ɛ}_{L} {μ}_{L}}}{\sqrt{{ɛ}_{L} {μ}_{L}} - \sqrt{{ɛ}_{B} {μ}_{B}}}$$

In this context, the index L represents air by way of example and describes the medium above the medium (filling material) to be measured.

In this context, the index B represents the base by way of example and describes the medium to be measured.

The value to be measured is \sqrt{∈_{B}μ_{B}}. From this, conclusions can be drawn as to the composition of the medium. For the process industry, this is advantageous for establishing variations in the substance properties.

Thus, for \sqrt{∈_{B}μ_{B}}:

$$\sqrt{{ɛ}_{B} {μ}_{B}} = \sqrt{{ɛ}_{L} {μ}_{L}} - \frac{\sqrt{{ɛ}_{L} {μ}_{L}}}{{a}_{1}}$$

A sufficiently precise approximation for \sqrt{∈_{L}μ_{L}} is \sqrt{∈_{L}μ_{L}}=1.

Therefore:

$$\sqrt{{ɛ}_{B} {μ}_{B}} = 1 - \frac{1}{{a}_{1}}$$

For the relevant media, μ_{B}=1, and it is thus possible to calculate ∈_{B}. ∈_{B} is the dielectric constant. If the estimation is not to be made on the basis of measurement reliability, the required values can of course be parameterised, that is to say be replaced by real or at least approximate values.

### Determining the Probe Length/Container Height/Location of a Stationary Reflector

To determine the probe length, the following are required:

1. track for the fill level
2. track for the base/container base

By a derivation not described in greater detail, the following correspondence is obtained for the parameter a₀:

$${a}_{0 } = - \frac{\sqrt{{ɛ}_{L} {μ}_{L}} \cdot \sqrt{{ɛ}_{B} {μ}_{B}}}{\sqrt{{ɛ}_{L} {μ}_{L}} - \sqrt{{ɛ}_{B} {μ}_{B}}} \cdot {d}_{Bottom}$$

With the above approximations:

$${d}_{Bottom} = - \frac{1 - \sqrt{{ɛ}_{B} {μ}_{B}}}{\sqrt{{ɛ}_{B} {μ}_{B}}} = \frac{{a}_{0}}{1 - {a}_{1}}$$

As noted previously, d_{Bottom} generally represents the position of the base, the probe end or a stationary reflector below the filling material surface. d_{Bottom} is the physical distance to the corresponding stationary reflector.

An advantage of this method is that the container does not have to be emptied so as to determine the position of the container base or the probe end. Parameter-free operation of a radar fill-level measurement device is thus made possible, or the parameterisation is facilitated (container height/probe length need not be inputted).

### Detecting Soiling

With the determined probe length (in the case of guided microwaves), if the probe length has been parameterised in advance in the factory or the client has inputted it manually, a soiled probe can be detected. This function is used for diagnosis! Soiling of the probe, whether as a result of local adhesion or soiling/wetting or the entire probe, leads to a reduction in the propagation speed of the electromagnetic wave. The measured probe end then differs from the parameterised probe end, and this indicates soiling.

Subsequently, a spoiling report can be made and/or the measurement values can be corrected automatically.

### Calculating the Quality of the Determined Dielectric Constant

The estimator determines the parameters a₀ and a₁ synchronously. The estimator is the program which may run for each measurement. In this way, for every calculated dielectric constant a probe length can also be determined. If a probe is not soiled or does not have any depositions formed thereon, the quality of the determined dielectric constant can be ascertained. If the calculated probe length is in a range around the parameterised probe length, it can be assumed that the dielectric constant was determined properly. Of course, the quality can be expressed as a percentage, 0% . . . 100%, depending on how much the calculated probe length and the parameterised probe length diverge from one another.

### Detecting Covered Interference Echoes

A covered interference echo is a reflection point which is located below the medium to be measured or has already been covered by the medium. The signal component which penetrates into the medium can be reflected on a reflection point which is already covered and thus appear as an echo in the echo curve. In this context, interference echo means that this is not the fill level and thus has an interference effect on the received signal.

For determining covered interference echoes, the following are required:

1. track for the fill level
2. any track below the fill level track

The “base position” d_{Bottom} is calculated for each track. If d_{Bottom} is within the probe length, this must be a covered interference echo, since the projection of the position onto a metrically measurable value is within the probe length. If the calculated base position is outside the probe length, this can only be a multiple reflection.

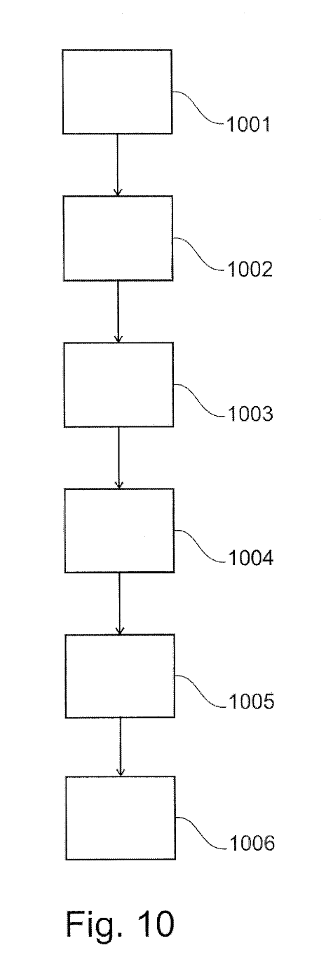

FIG. 10 is a flow chat of a method in accordance with one embodiment of the invention.

In step 1001, a transmission signal in the form of an electromagnetic or acoustic pulse is emitted towards the filling material surface by a transceiver unit. This pulse is subsequently reflected by the various reflectors in the container, and the resulting echo curve which comprises the corresponding various echoes is captured by the transceiver unit (step 1002).

Subsequently, in step 1003, the transceiver unit passes the echo curve to the evaluation unit, which in step 1004 carries out a tracking method for grouping the echoes. In step 1005, a linear relationship between two tracks is formed, and in step 1006, one or more unknowns are determined from this relationship.

For completeness, it should be noted that “comprising” and “having” do not exclude the possibility of other elements or steps, and “an” or “a” does not exclude the possibility of a plurality. It should further be noted that features or steps which were disclosed with reference to one of the above embodiments can also be used in combination with other features or steps or other above-disclosed embodiments. Reference numerals in the claims should not be considered as limiting.

1-15. (canceled)

16. A delay-based fill-level measurement device, comprising:
a transmitter unit emitting a transmission signal which is reflected on a filling material surface of a filling medium and at least on a second reflector;
a receiver unit detecting the reflected transmission signal which is an echo curve and which includes a plurality of echoes; and
an evaluation unit carrying out a tracking method to group echoes, which in each case originate from the same reflector, from echo curves which are captured at different times, the evaluation unit being configured so as to carry out the following steps:
(a) determining a first track of a first group of echoes which originate from a first reflector and a second track of a second group of echoes which originate from a second reflector, each track describing the delay of the corresponding transmission signal from the transmitter unit to the reflector assigned to the track and back to the receiver unit at different times;
(b) determining a linear relationship between the first track and the second track; and
(c) determining one or more unknowns from the linear relationship between the first track and the second track.

17. The device according to claim 16, wherein the first group of echoes is the transmission signals reflected from the filling material surface.

18. The device according to claim 16, wherein the unknown is the expected position of an echo, assigned to the second track, of a further echo curve, the further echo curve being received at a later moment than the other echo curves.

19. The device according to claim 16, wherein the unknown is the dielectric constant of the filling medium

20. The device according to claim 16, wherein the device is a TDR fill-level measurement device and where the unknown is the length of a probe of the TDR fill length measurement device.

21. The device according to claim 20, wherein the evaluation unit is configured so as to detect, from the determined length of the probe by comparison with the actual probe length, whether the probe is soiled.

22. The device according to claim 20, wherein n the evaluation unit is configured so as to calculate, from the determined length of the probe by comparison with the actual probe length, a quality of the dielectric constant.

23. The device according to claim 16, wherein the unknown is the height of a container in which the filling medium is located or the position of a stationary reflector in the container.

24. The device according to claim 20, wherein the evaluation unit is configured so as to carry out the following steps:
calculating the position of the container base dBottom;
determining whether the calculated position of the container base is above a lower end of the probe; and
classifying the calculated position as the position of a reflector which is not the container base if the calculated position of the container base is above the lower end of the probe.

25. The device according to claim 16, wherein the tracks and the linear relationship between the first track and the second track are determined by an estimation method.

26. The device according to claim 16, wherein the linear relationship between the first track and the second track is determined by a recursive method.

27. A delay-based fill-level measurement method for carrying out a tracking method for grouping echoes, which in each case originate from identical reflectors, from echo curves captured at different times, comprising the steps of:
(a) transmitting a transmission signal, which is reflected on a filling material surface of a filling medium and at least on a second reflector;
(b) capturing the reflected transmission signal, which is an echo curve including a plurality of echoes;
(c) determining a first track of a first group of echoes which originate from a first reflector and a second track of a second group of echoes which originate from a second reflector, each track describing the delay of the corresponding transmission signal from the transceiver unit to the reflector assigned to the track and back to the transceiver unit at different times; and
(d) determining a linear relationship between the first track and the second track; and
(e) determining one or more unknowns from the linear relationship between the first track and the second track.

28. A processor for carrying out a tracking method for grouping echoes, which in each case originate from identical reflectors, from echo curves captured at different times, the processor being configured so as to carry out the steps (c), (d) and (e) of claim 27.

29. Non-transitory computer-readable medium, on which a program for carrying out a tracking method for grouping echoes, which in each case originate from identical reflectors, from echo curves captured at different times, is stored, which when implemented on a processor of a delay-based fill-level measurement device instructs the processor to carry out the steps (c), (d) and (e) of claim 27.

30. A non-transitory program element for carrying out a tracking method for grouping echoes, which in each case originate from identical reflectors, from echo curves captured at different times, which when implemented on a processor of a delay-based fill-level measurement device instructs the processor to carry out the steps (c), (d) and (e) of claim 27.
